(19) United States
(12) Patent Application Publication
(10) Pub. No.: US 2010/0148567 A1
(43) Pub. Date: Jun. 17, 2010

(54) TEMPORARY POWER EQUIPMENT TRANSPORT SYSTEM FOR MOVING MINING EQUIPMENT AND METHOD OF USE

(76) Inventor: Gary Douglas McClure, Mannington, WV (US)

Correspondence Address: CLARK & BRODY, 1700 Diagonal Road, Suite 510, Alexandria, VA, 22314, US

(21) Appl. No.: 12/637,033

(22) Filed: Dec. 14, 2009

Related U.S. Application Data
(60) Provisional application No. 61/193,644, filed on Dec. 12, 2008.

(51) Int. Cl. E21C 37/00; E21C 27/00; E21C 35/24; E21C 41/16; B60K 25/00

(52) U.S. Cl. 299/64; 180/53.5

(57) ABSTRACT

A system for supplying temporary power to a piece of mining equipment includes a power inverter and controller system. The system uses the battery power of a first piece of mining equipment to temporarily move and/or power a second piece of mining equipment. The first piece of mining equipment is preferably a battery powered mobile piece of equipment so that the first piece of mining equipment can move in conjunction with the second piece of mining equipment. The controller can be remote so that an operator can power and/or move the second piece of mining equipment from a distance, either on ground or on the first piece of mining equipment.

This application claims priority under 35 U.S.C. §119(e) based on provisional patent application no. 61/193,644 filed on Dec. 12, 2008, which is incorporated in its entirety herein.

### FIELD OF THE INVENTION

The present invention relates to a temporary power equipment transport system for moving/powering mining equipment and a method of use, and particularly a system that includes a power inverter and controller, whereby an operator can use the power source of the one piece of mining equipment to move/power a second piece of equipment.

### BACKGROUND ART

In the mining industry, mining equipment is generally powered using electricity. The equipment used for the actual mining includes miners, which are machines that are designed to continuously mine a desired material. Joy Manufacturing is one manufacturer of these types of machines. These machines are equipped with mining heads, a traction system, and a conveyor system, whereby the components work together to permit the mining heads to mine the material in a mine and transport it away from the mining site. The traction system allows the miner to reach the desired mining site, move or tram during the mining process, and leave the mining site and/or mine.

During operation of the miners, they are connected to differently located sources of power, typically AC power, in the mine. Since the miners are continuously moving, their connection to a source of power in the mine must be continually moved since the miner's movement eventually moves it from the source of electrical power such that it must be connected to another source of power. This “plugging in” to various power stations in the mine is a time consuming process, which reduces productivity during the mining operation.

Normally, the miner carries 600 feet of power line to hook to different power stations in the mine. Thus, when a miner is to be moved from a given position to another position that is further in distance than the power line length, the power line must be moved to the next power station to continue the miner's movement. This procedure is time consuming. Moreover, since the mining operation is halted during the movement of the miner, productivity of the mine is affected as well. In certain instances, the miner may have to be moved from the entire mine, which could be 5000 feet or more, and this would involve multiple power line moves between power stations.

As such, a need exists to provide improved methods and systems to permit the miner or other powered mining equipment to be moved/powered during the mining process without having to continually connect to differently-located power stations.

The present invention solves this need by providing a system that allows the miner or other mining equipment to be powered by a second piece of mining equipment that is battery powered. Preferably, each piece of mining equipment is mobile. The inventive system, in a preferred mode, allows an operator of the second piece equipment to control the movement of the first piece of mining equipment and move it to a desired location without the need for connection to any power stations.

### SUMMARY OF THE INVENTION

The invention relates to methods and apparatus for moving or powering a piece of mining equipment that are located in a mine. In one method aspect of the invention, a first piece of mining equipment is provided that is driven or powered using DC battery power. The DC battery power of the first piece of mining equipment is converted to AC power. A second piece of mining equipment is provided that is an AC powered traction system or other AC powered system. The AC power provided by the first piece of equipment is used and controlled to power the second piece of equipment. The control of the power being supplied to the second piece of equipment is done at the first piece of equipment, or remote from the first piece of equipment. If not at the first piece of equipment, the control can take place at the second piece of equipment or a place remote from the second piece of equipment. The invention permits an operator of the first piece of mining equipment to move or power the second piece of mining equipment using the DC battery power of the first piece of mining equipment.

The invention also entails an improvement in mining equipment that is driven or powered using DC battery power. The improvement comprises a power inverter to convert the DC power of the first piece of mining equipment to AC power. In addition, means for connecting an output of the power inverter to an AC-powered traction system or another AC-powered system of a second piece of mining equipment is provided. A control located on the first piece of mining equipment or elsewhere is provided for controlling output of the power inverter to control movement of the AC-powered traction system or to control movement of the AC-powered system. This control enables an operator of the first piece of mining equipment or another worker to move or power the second piece of mining equipment.

The invention system that accomplishes the power inversion and ability to provide the AC power to the second piece of mining equipment can be made portable in nature so that is can be used with a variety of mining equipment that would act as the first piece of mining equipment mentioned above. In this aspect of the invention, a temporary power equipment transport system is provided that comprises a power inverter having means for coupling to a DC power source of a first piece of mining equipment, converting the DC power to AC power, and providing the AC power to an AC-powered traction system or an AC-powered system of a second piece of mining equipment. The system also includes a controller adapted to control input of the AC power to the traction system or the AC-powered system of the second piece of mining equipment. The controller permits an operator to remotely supply power to the traction system or the AC-powered system and move or power the second piece of mining equipment using the DC power source of the first piece of mining equipment.

The first and second pieces of mining equipment can be mobile so that the DC power of the first piece of mining equipment can be used to move the second piece of mining equipment. If the first piece of mining equipment is mobile, the second piece of mining equipment can move in conjunction with the movement of the first piece of mining equipment

In one embodiment, the first piece of mining equipment can be a miner and the second piece of mining equipment can be a mobile material loader.

While the DC battery on the first piece of mining equipment can be any voltage, a preferred battery size is 128 Volt.

### BRIEF DESCRIPTION OF THE DRAWINGS

FIG. 1 is a perspective view of a conventional piece of mining equipment known as a miner.

FIG. 2 is a perspective view of a conventional piece of mining equipment known as a mining material loader.

FIG. 3 is a schematic drawing illustrating components and component interfacing according to the invention.

FIG. 4 is a schematic drawing showing the battery, inverter, control and second piece of mining equipment being powered.

FIG. 5 is a schematic drawing showing the system of FIG. 4 in greater detail.

### DESCRIPTION OF THE PREFERRED EMBODIMENTS OF THE INVENTION

The invention provides a significant improvement in operation of a mine. When practicing the method of the invention and using the inventive system, an AC powered piece of mining equipment can be moved and/or powered using the inventive system. This avoids the need to move the AC-powered piece of mining equipment from to another source of AC power, particularly if the location of the source of AC power is inconvenient. By eliminating the requirement to have to switch between AC power sources, the mining equipment can be used in a more efficient manner and mine productivity is increased.

The present invention, in one embodiment, comprises a system that provides a portable source of electrical power for powering miners or other mobile mining equipment in mines. The system includes a power inverter and controller that provide a source of power to that traction system of the miner. This enables an operator of the system to move or tram the miner to a desired location without the need for connection to a power station in the mine.

The portable source of electrical power is preferably a second piece of mobile mining equipment that is powered by one or more DC batteries. This piece of equipment, which is designed for movement in the mine using its set of batteries, already has the battery capacity to be able to move a piece of mining equipment such as a miner.

While any number of high voltage batteries can be used depending on the equipment being powered, a preferred battery is a 128 volt DC battery, which is the type found in material loaders used in the mines. An example of one material loader is one manufactured by Southern Mine Service of Shinnston W.V. Thus, it is possible to use the battery of the material loader to power the miner in connection with the inventive system. This removes the need to have a portable battery system in the mine that provides no other function than temporary power.

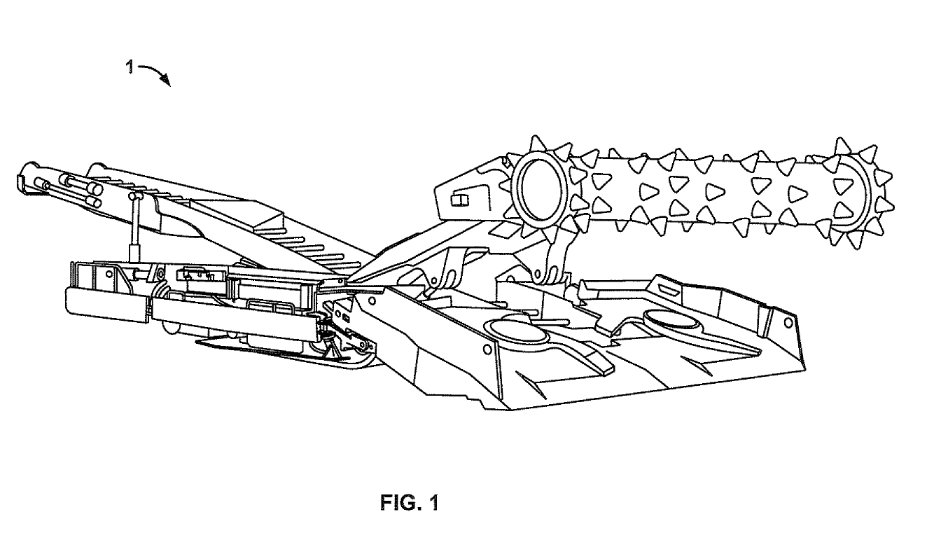

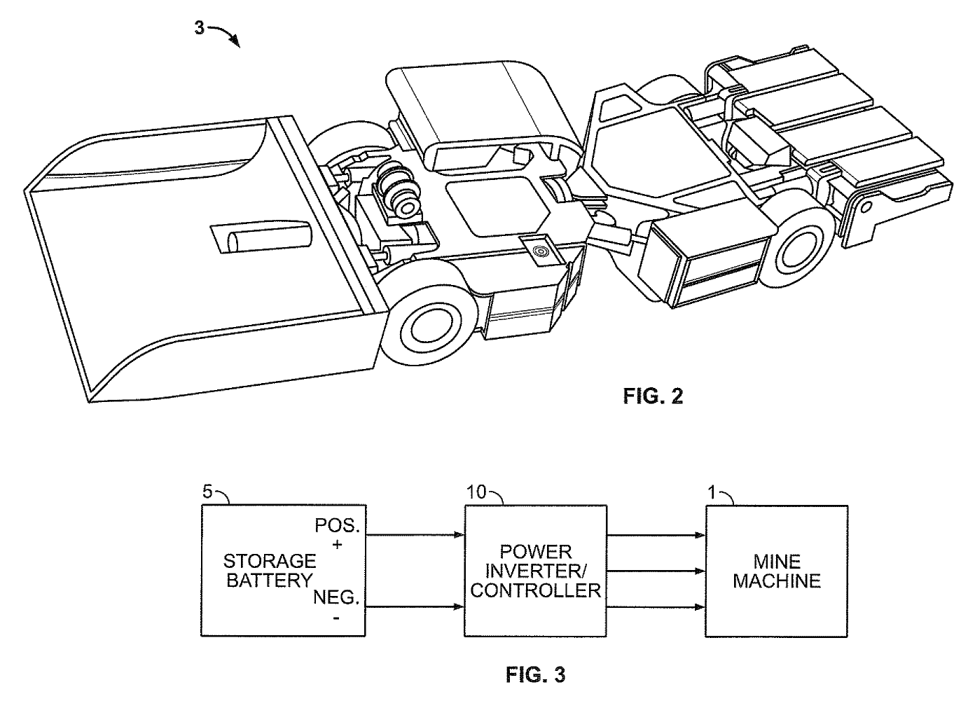

Still referring to the first embodiment of the invention, FIG. 1 illustrates a miner 1 and FIG. 2 illustrates a material loader 3. The miner 1 is one manufactured by Joy Manufacturing, but any piece of mining equipment, including those that are mobile and not mobile, could be moved/powered using the invention system. The material loader is an example of another piece of mobile mining equipment that it battery powered, is made by Southern Mine Service of Shinnston, W.V., and is capable of providing the DC battery power needed for conversion and supply to the mining equipment needing moving or powering. Of course, other pieces of mining equipment having battery power could be employed with the inventive system.

FIG. 3 also depicts the battery 5 of loader 3, the system 10, and the miner 1 in schematic form. While the system 10 is used in connection with the miner of FIG. 1, power could be supplied to other equipment in the mine as well, mobile or stationary. The system 10 of FIG. 3 represents the ability to convert the DC power to AC power and control it for powering and/or moving the second piece of mining

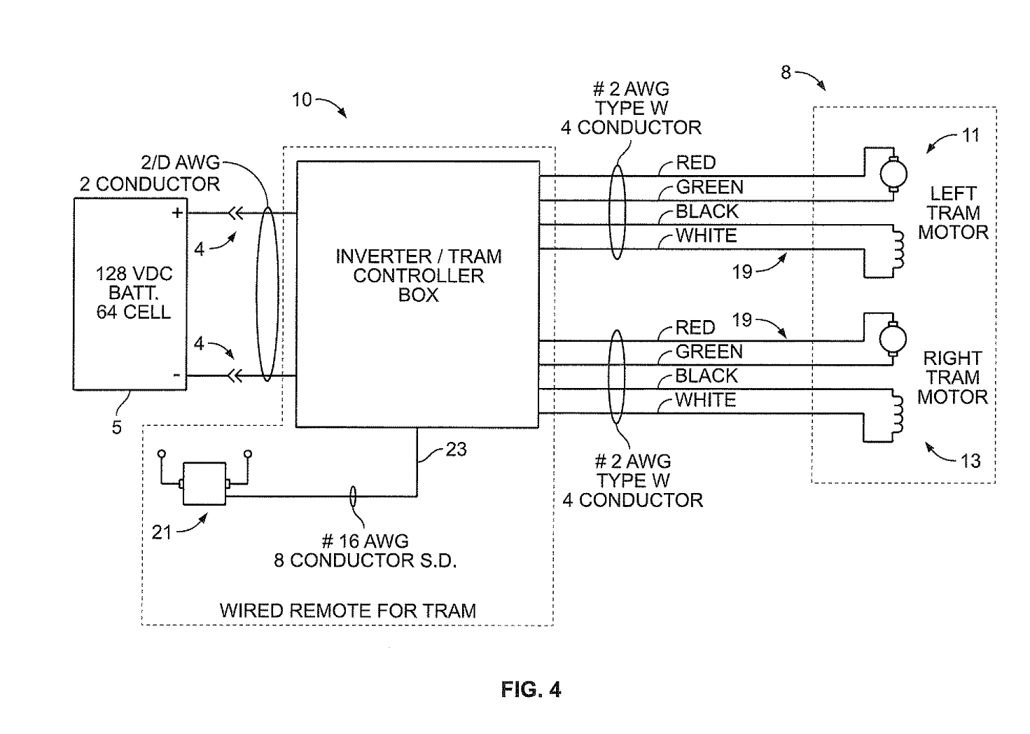

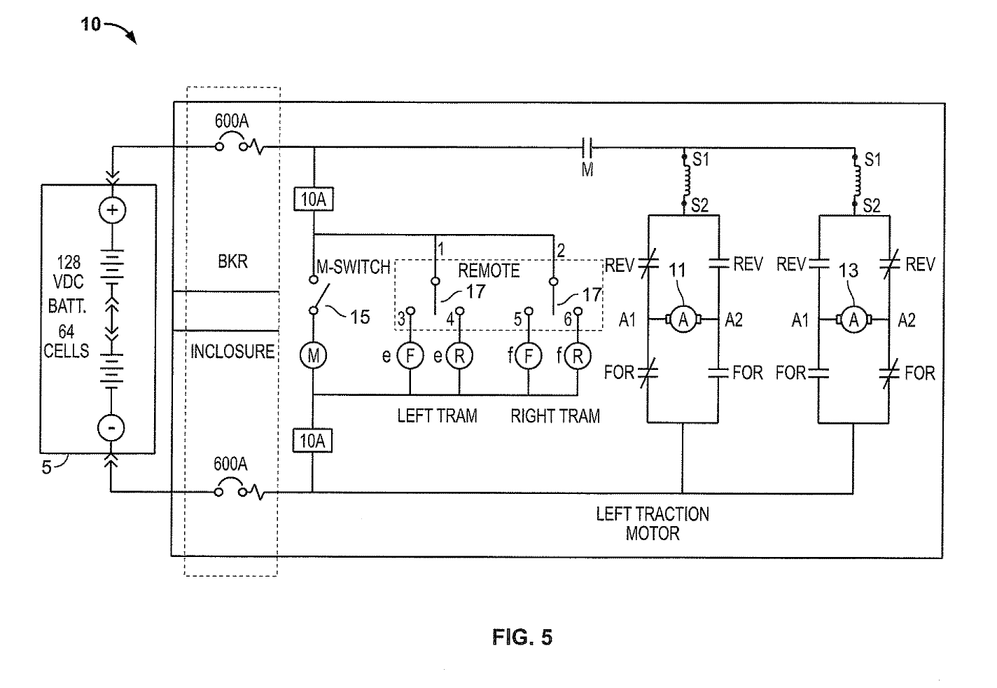

FIGS. 4 and 5 show more detailed drawings of the FIG. 3 system, wherein the battery 5, the system 10, and traction system 8 of the miner 1 are illustrated. The right and left motors 11 and 13, respectively, of the traction system 8 of a miner are shown. The battery 5 is linked to the system using a #2awg 2 conductor cable 4 and a connector (not shown). The connector can be a 400 amp connector or any other connector that would provide the necessary link between the battery and system 10.

The system 10 includes a main contactor 15 and a pair of forward/reverse contactors 17. The system 10 connects to the miner with a pair of cables 19 so that the battery power can be supplied to the traction motors 11 and 13 of the miner 1 and the miner 1 can be moved as desired. While the cables 19 can be any type, a preferred type includes a #2awg type W four conductor type.

FIG. 5 shows a more detailed schematic of the battery, the system, and the traction motor arrangement. A 600 amp breaker is provided to protect the traction motors and operation. While the system 10 could have the operating controls as part of the system itself, the embodiment of FIG. 3 includes a remote operating or controller unit 21, which has the forward and reverse contactors 17, and which is linked to the other components of the system via cable 23, which is shown as a #16awg 8 conductor cable. This allows the traction system 8 of the miner to be controlled at the material loader 3 itself or some other location, e.g., on the ground. It is preferred to have the operating unit 21 on the loader 3 so that the operator of the loader can move the miner while still having access to the controls of the loader 3. Of course, a remote operating unit could be portable so that it could be used on the loader or carried by an operation walking with the miner when the miner was being moved. Moreover, the system 10 could be portable as well so that it could be easily removed from the loader 3 and linked to some other battery power source to provide a portable source of AC power. The unit 21 could also be a wireless unit, with the system 10 having the necessary transmitter and receiver to allow communication between the unit 21 and remaining components of the system to allow for remote operation of the mining equipment being powered. The unit 21 can be considered to be either associated with the first piece of mining equipment or remote therefrom. Being remote includes an operator or other worker being removed from the first piece of mining equipment and this removed position could be merely a distance from the first piece of mining equipment or on or near the second piece of mining equipment being powered.

The system 10 inverts the DC power of the battery to AC power for the AC-powered miner. While a particular electrical circuit in FIG. 5 is shown to accomplish the inversion, any circuit that would invert the DC power of the battery 5 for use in the AC-powered system of the other piece of mining equipment could be employed. In addition, the system could also power a DC-powered piece of mining equipment if so desired. However, since most mining equipment is AC-powered, it is preferred that the system 10 be capable of inverting the DC power of the loader or other piece of mining equipment to AC power for use by the second piece of mining equipment.

In one mode of operation, when a particular piece of mining equipment such as miner 1 needs to be efficiently moved, a material loader 3 is driven in proximity to the miner 1 with the system 10 located on the loader 3. The distance between the loader 3 and miner 1 is that distance that will permit the system 10 to connect to the traction system 8 of the miner 1. This distance is basically a function of the length of the cables 19. The system 10 has means for connecting to the battery of the loader 3, e.g., cables 19. As noted above and shown in the electrical circuitry of FIGS. 4 and 5, the system also includes means for inverting the DC power of the battery to AC power as well as permitting an operator to remotely control the AC-powered system, e.g., the traction system of the miner.

Once the system 10 is linked between the miner 1 and loader 3, an operator can access the operating control unit 21, which could be located on the loader 3, or hand held, and provide power to the traction system of the miner and move it to its desired location.

Since the loader 3 is also mobile, the operator of the loader could tram the miner to its desired destination, also covering the trammed distance using the loader. In this scenario, one operator could move the loader with one operator moving the miner. Alternatively, the miner and loader could be moved sequentially, with the sequence and distance moved determined mainly on the length of cable 19 linking the system 10 to the miner 1. Another mode would have the operator of the loader move the miner and loader at the same time by having the control unit 21 on the loader and in a location where the operator of the loader can also tram the loader while moving the miner.

While not shown in the drawings, the power could be increased to 480V, 550V, or 950V using a transformer as part of the system 10. Since this modification would be well within the skill of the art, a detail of it is not necessary for understanding of this aspect of the invention.

Although the system 10 is shown linking the battery of the loader 3 to the traction system 1, the system could also link any battery-powered vehicle piece of mining equipment to another piece of mining equipment needing AC power. For example, a battery powered vehicle other than a loader could be employed to power a hydraulic pump or electrical motor in need of temporary power.

As such, an invention has been disclosed in terms of preferred embodiments thereof which fulfills each and every one of the objects of the present invention as set forth above and provides a new and improved system to provide power to mining equipment and a method of use.

Of course, various changes, modifications and alterations from the teachings of the present invention may be contemplated by those skilled in the art without departing from the intended spirit and scope thereof. It is intended that the present invention only be limited by the terms of the appended claims.

I claim:

1. A method of moving or powering a piece of mining equipment comprising:
providing a first piece of mining equipment that is driven or powered using DC battery power and a second piece of mining equipment that has an AC power-powered traction system or other AC powered system;
converting the DC battery power to AC power;
controlling supply of the AC power to the AC-powered traction system or other AC-powered system of the second piece of mining equipment at the first piece of mining equipment or remote from the first piece of mining equipment so that an operator of the first piece of mining equipment can move or power the second piece of mining equipment using the DC battery power of the first piece of mining equipment.

2. In a first piece of mining equipment that is driven or powered using DC battery power, the improvement comprising:
a power inverter to convert the DC battery power of the first piece of mining equipment to AC power;
means to connect an output of the power inverter to an AC-powered traction system or another AC-powered system of a second piece of mining equipment;
a controller located on the first piece of mining equipment or elsewhere for controlling output of the power inverter to control movement of the AC power to the AC-powered traction system or other AC-powered system of the second piece of mining equipment so that an operator of the first piece of mining equipment or another worker can move or power the second piece of mining equipment.

3. A temporary power equipment transport system comprising:
a power inverter having means for coupling to a DC power source of a first piece of mining equipment, converting the DC power to AC power, and providing the AC power to an AC-powered traction system or an AC-powered system of a second piece of mining equipment.
a controller adapted to control input of the AC power to the traction system or the AC-powered system of the second piece of mining equipment, the controller permitting an operator to supply power to the traction system or the AC-powered system and move or power the second piece of mining equipment using the DC power source of the first piece of mining equipment.

4. The method of claim 1, wherein the first and second pieces of mining equipment are mobile so that the DC power of the first piece of mining equipment can be used to move the second piece of mining equipment and the second piece of mining equipment can move in conjunction with the movement of the first piece of mining equipment.

5. The improvement of claim 2, wherein the first piece of mining equipment is a miner and the second piece of mining equipment is a mobile material loader.

6. The improvement of claim 2, wherein the DC battery is 128 Volt.

7. The method of claim 1, wherein the first piece of mining equipment is a miner and the second piece of mining equipment is a mobile material loader.

8. The improvement of claim 2, wherein the controller includes a wireless remote control capability so that the control of the AC power being supplied to the second piece of mining can be done at a location removed from the first piece of mining equipment.

9. The system of claim 3, wherein the controller includes a wireless remote control capability so that the control of the AC power being supplied to the second piece of mining can be done at a location removed from the first piece of mining equipment.
